(19) United States
(12) Patent Application Publication
(10) Pub. No.: US 2021/0209496 A1
(43) Pub. Date: Jul. 8, 2021

(54) SPATIO-TEMPORAL EVENT DATA ESTIMATING DEVICE, METHOD, AND PROGRAM

(71) Applicant: NIPPON TELEGRAPH AND TELEPHONE CORPORATION, Tokyo (JP)

(72) Inventors: Maya OKAWA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/058,613

(22) PCT Filed: May 14, 2019
(86) PCT No.: PCT/JP2019/019188

§ 371 Date: Nov. 24, 2020

(30) Foreign Application Priority Data
May 30, 2018 (JP) 2018-103533

(51) Int. Cl. G06N 7/00

(52) U.S. Cl. CPC G06N 7/005

(57) ABSTRACT

A parameter estimation unit (16) estimates a set of parameters so as to optimize a likelihood function of a strength function expressing the event occurrence probability of a type m space-time event at a time t and a geospatial location s when the strength function is modelled with use of the occurrence probability of the type m space-time event at the time t and the geospatial location s, the function expressing the degree of influence of the event occurrence history, the value of the strength function representing the event occurrence probability in an observation section that includes the time t and the geospatial location s, and the relationship between the type m and the type of the event occurrence history included in the observation section, and here, the estimated parameters include the value of the strength function expressing the event occurrence probability in the observation sections, the relationship between types, and the function expressing the degree of influence of the event occurrence history.

### TECHNICAL FIELD

The present invention relates to a space-time event data estimation device, method, and program for predicting space-time event data.

### BACKGROUND ART

A space-time process model is a technique for modelling data (event data) that extends continuously in time and space. A space-time point process is used when modelling phenomena such as earthquakes, crime, and the spread of diseases. The spatio-temporal Hawkes process has been proposed as a point-process model for handling pieces of space-time data (NPL 1). This model is based on the hypothesis that the occurrence of an event is influenced by the same event in the past and past events of other data, and makes it possible to learn a co-occurrence relationship or a competitive relationship between data points.

However, a big drawback of the technique in NPL 1 is that it cannot handle missing values in data. This drawback becomes a big problem when the technique is applied to the field of transportation, for example. In the case of transportation relationships regarding the movement paths of people, cars, and the like, the space-time event data includes missing values. For example, the paths of cars are only observed on roads.

A temporal Hawkes process is also known as a Hawkes point-process model that takes missing values into account (NPL 2).

### CITATION LIST

### Non Patent Literature

[NPL 1] OGATA, Yosihiko. Space-time point-process models for earthquake occurrences. Annals of the Institute of Statistical Mathematics, 1998, 50.2: 379-402.
[NPL 2] LE, Triet M. A Multivariate Hawkes Process with Gaps in Observations. IEEE Transactions on Information Theory, 2018, 64.3: 1800-1811.

### SUMMARY OF THE INVENTION

### Technical Problem

However, with conventional techniques, it is not possible to handle space-time data that includes missing values. For this reason, there has been a problem that an erroneous estimation or prediction is made if the data includes missing values.

The present invention was achieved in light of the foregoing circumstances, and an object of the present invention is to provide a space-time event data estimation device, method, and program that can precisely estimate an occurrence probability for various types of space-time event data that includes missing values.

### Means for Solving the Problem

In order to achieve the above object, a space-time event data estimation device according to an aspect of the present invention includes: an accepting unit configured to accept an event occurrence history for each of a plurality of types of space-time events; and a parameter estimation unit configured to, based on the event occurrence history accepted by the accepting unit, estimate parameters so as to optimize a likelihood function of a strength function expressing an event occurrence probability of a type m space-time event at a time t and a geospatial location s when the strength function is modelled with use of an occurrence probability of the type m space-time event at the time t and the location s, a function expressing a degree of influence of an event occurrence history of events before the time t, a value representing an event occurrence probability in a type m observation section that includes the time t and the location s among a plurality of observation sections determined in advance for respective types, and a relationship between the type m and the type of the event occurrence history included in the type m observation section that includes the time t and the location s, the estimated parameters including a value expressing the event occurrence probability in the observation sections, the relationship between types, and the function expressing the degree of influence of the event occurrence history.

Also, a space-time event data estimation method according to an aspect of the present invention includes: accepting, by an accepting unit, an event occurrence history for each of a plurality of types of space-time events; and estimating, by a parameter estimation unit, based on the event occurrence history accepted by the accepting unit, parameters so as to optimize a likelihood function of a strength function expressing an event occurrence probability of a type m space-time event at a time t and a geospatial location s when the strength function is modelled with use of an occurrence probability of the type m space-time event at the time t and the location s, a function expressing a degree of influence of an event occurrence history of events before the time t, a value representing an event occurrence probability in a type m observation section that includes the time t and the location s among a plurality of observation sections determined in advance for respective types, and a relationship between the type m and the type of the event occurrence history included in the type m observation section that includes the time t and the location s, the estimated parameters including a value expressing the event occurrence probability in the observation sections, the relationship between types, and the function expressing the degree of influence of the event occurrence history.

Also, a program according to an aspect of the present invention is a program for causing a computer to function as the constituent units of the space-time event data estimation device.

### Effects of the Invention

As described above, a space-time event data estimation device, method, and program of the present invention obtain an effect of being able to accurately estimate an occurrence probability for various types of space-time event data that includes missing values, by estimating parameters so as to optimize a likelihood function of a strength function expressing an event occurrence probability of a type m space-time event at a time t and a geospatial location s when the strength function is modelled with use of an occurrence probability of the type m space-time event at the time t and the location s, a function expressing a degree of influence of an event occurrence history of events before the time t, a value representing an event occurrence probability in a type m observation section that includes the time t and the location s among a plurality of observation sections determined in advance for respective types, and a relationship between the type m and the type of the event occurrence history included in the type m observation section that includes the time t and the location s, the estimated parameters including a value expressing the event occurrence probability in the observation sections, the relationship between types, and the function expressing the degree of influence of the event occurrence history.

### BRIEF DESCRIPTION OF DRAWINGS

FIG. 1 is a diagram showing an example of an occurrence history of various types of space-time event data.

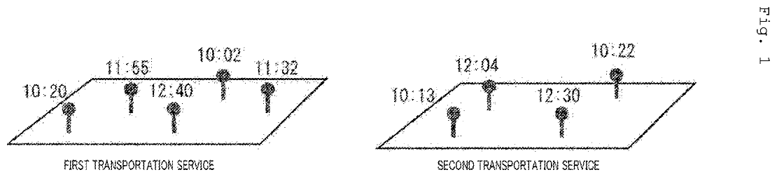

FIG. 2 is a diagram for describing a multivariate Hawkes process.

FIG. 3 is a block diagram of a space-time event data estimation device in an embodiment of the present invention.

FIG. 4 is a diagram showing an example of history information of various types of space-time event data stored in a space-time event data storage device.

FIG. 5 is a flowchart showing a learning processing routine of the space-time event data estimation device in an embodiment of the present invention.

FIG. 6 is a flowchart showing a data prediction processing routine of the space-time event data estimation device in an embodiment of the present invention.

### DESCRIPTION OF EMBODIMENTS

Hereinafter, embodiments of the present invention will be described in detail with reference to the drawings.

Overview

This embodiment of the present invention relates to technology for, when given various types of unfixed-interval space-time event data, estimating co-occurrence between the types of space-time event data, and performing missing value complementing and predicting with respect to the space-time event data. This unfixed-interval space-time event data is data made up of pairs of an occurrence location and time of a random phenomenon (event), and in the field of transportation flow, is a time series made up of pairs of a departure time and the latitude/longitude of a departure point of a vehicle, for example.

A spatio-temporal Hawkes process that takes missing values into account is proposed in this embodiment of the present invention. Although a temporal Hawkes process (NPL 2) is already known as a Hawkes point-process model that takes missing values into account, this embodiment of the present invention extends that model to space-time. In other words, the spatio-temporal Hawkes process is extend to a format that takes missing values into account. A point-process model is for modelling the occurrence probability of an event with use of a function in space-time called a “strength function”. The strength function of the spatio-temporal Hawkes process is defined as follows.

$$\begin{matrix}[ Formula . 1 ] & \\ {λ}_{m} ( t , s \vert {H}_{t} ) = {u}_{m} ( t , s ) + {\sum }_{{t}_{i} < t} g ( t - {t}_{i} , s - {s}_{i} ) & \end{matrix}$$

Here, tᵢ is the time of the i-th event, and sᵢ is the location (latitude/longitude). Hₜ is a history of occurrence times and locations of events before the time t. Also, uₘ(t,s) is a function (“background rate”) expressing the occurrence probability of a unique event in type m space-time event data (transportation service). Also, g is a function expressing the degree of influence of the history, and here, a non-negative function such as a normal kernel function or a power decay attenuation function is used.

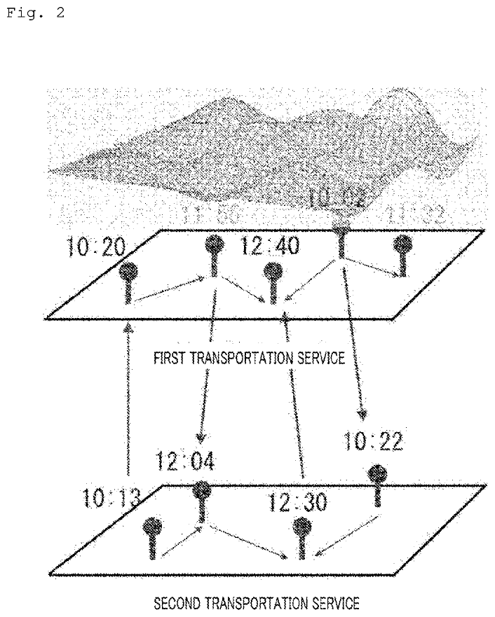

The present embodiment handles the case of being given a history {(tᵢ,sᵢ,mᵢ)}^{N}ᵢ₌₁ of multiple of types of space-time event data. In the previously-described example, tᵢ is a time, sᵢ is a geospatial location, mᵢ is the index of the type of transportation service, and N is the data count. The occurrence probability of a piece of space-time event data in the type m transportation service can be modelled by a multivariate Hawkes process defined by the following strength function (see FIG. 2).

$$\begin{matrix}[ Formula . 2 ] & \\ {λ}_{m} ( t , s \vert {H}_{t} ) = {u}_{m} ( t , s ) + {\sum }_{{t}_{i} < t} {a}_{m , {m}_{i}} g ( t - {t}_{i} , s - {s}_{i} ) & \end{matrix}$$

Here, mᵢ is the index of the data (e.g., transportation service). The following new parameter has been introduced to the above expression, that is to say a new parameter that represents the relationship between the type m space-time event data (transportation service) and the type mᵢ space-time event data (transportation service).

a_{m,m}_{ᵢ}
Accordingly, a relationship between types of space-time event data (e.g., a competitive relationship or a co-occurrence relationship between transportation services) can be modelled. However, this model has a big problem in that it cannot handle missing values. Space-time event data often includes missing values. For example, taxi departure events are concentrated only along roads, and do not exist at other locations. The above-described model handles such missing values as 0, and thus has the problem of not being able to estimate appropriate parameters. Assume that the type m space-time event data has Kₘ observation sections. Let (c_{m,k}, d_{m,k}]^{Km}ₘ₌₁ be the time range in each observation section, and let (g_{m,k}, h_{m,k}]^{Km}ₖ₌₁ be the corresponding spatial domain. Assume that observations have not been obtained for other domains. In order to handle missing values, the strength function is replaced with the following expression.

$$\begin{matrix} [ Formula . 3 ] & \\ {λ}_{m} ( t , s \vert {H}_{t} ) = {u}_{m} ( t , s ) + ( {\overline{λ}}_{m} ( {c}_{m , k} , {g}_{m , k} ) - {u}_{m} ( t , s ) ) ) g ( t - {c}_{m , k} , s - {g}_{m , k} ) + {\sum }_{\text{?}} {a}_{m , {m}_{i}} g ( t - {t}_{i} , s - {s}_{i} ) \\ \text{?} \text{indicates text missing or illegible when filed} & ( 3 )\end{matrix}$$

Here, uₘ(t,s) is the occurrence probability of the type m space-time event at the time t and the geospatial location s, and g is a function expressing the degree of influence of the event occurrence history of events before the time t.

a_{m,m}_{ᵢ}
The above is the relationship between type mᵢ and type m.
(c_{m,k},d_{m,k}]
The above is the time range of the observation section k among the observation sections that were determined in advance for the type m.
(g_{m,k},h_{m,k}]
The above is the spatial domain of the type m observation section k. In this way, the observation section is defined by a combination of a time range and a spatial domain.

Also, the following is an unknown parameter that represents the value of a strength function that expresses the event occurrence probability of an event in the observation section k that includes the time t and the geospatial location s among the Kₘ observation sections that were determined for the type m.

λ̅_{m,k}≡λ̅ₘ(c_{m,k},g_{m,k})
Through this formulation, it is possible to simultaneously complement a strength function in a missing domain and estimate a parameter. Using the new strength function, the likelihood function can be written as follows.

$$\begin{matrix}[ Formula . 4 ] & \\ L = {\sum }_{m ∈ M} {\sum }_{k = 1}^{{K}_{w}} {\int }_{\text{?}}^{\text{?}} {\int }_{\text{?}}^{\text{?}} {\overline{λ}}_{m} ( t , s ) dtds - {\sum }_{\text{?}} log ( {\overline{λ}}_{m} ( {t}_{i} , {s}_{i} ) ) \\ \text{?} \text{indicates text missing or illegible when filed} & ( 4 )\end{matrix}$$

Configuration of Space-Time Event Data Estimation Device of Embodiment of Present Invention

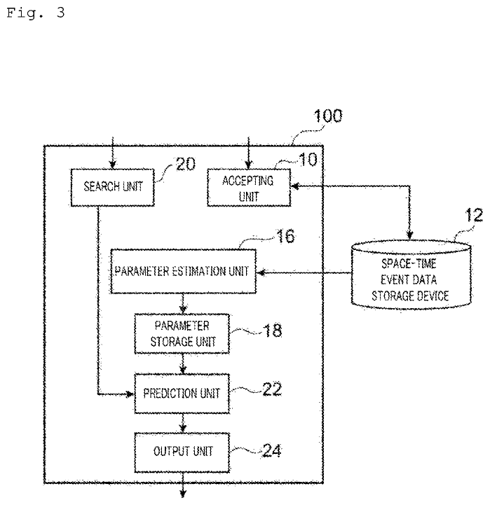

The following describes the configuration of a space-time event data estimation device according to an embodiment of the present invention. As shown in FIG. 3, a space-time event data estimation device 100 according to an embodiment of the present invention can be configured by a computer that includes a CPU, a RAM, and a ROM that stores various types of data and a program for executing later-described processing routines. Based on history information of various types of space-time event data, the space-time event data estimation device 100 infers a relationship between various types of space-time event data and predicts a time development of space-time event data.

As shown in FIG. 3, in terms of functionality, the space-time event data estimation device 100 includes an accepting unit 10, a parameter estimation unit 16, a parameter storage unit 18, a search unit 20, a prediction unit 22, and an output unit 24.

The accepting unit 10 accepts various operations made by a user with respect to data stored in a later space-time event data storage device 12. Examples of such operations include the registration, modification, and deletion of information stored in the space-time event data storage device 12.

Operations may be input to the accepting unit 10 using a keyboard, a mouse, menu screens, a touch panel, or any other means. The accepting unit 10 can be realized by a device driver of an input means such as a mouse, and menu screen control software.

The search unit 20 accepts information indicating a time and a location for which a prediction is to be made. Operations may be input to the search unit 20 using a keyboard, a mouse, menu screens, a touch panel, or any other means. The search unit 20 can be realized by a device driver of an input means such as a mouse, and menu screen control software.

The space-time event data storage device 12 stores history information of various types of space-time event data that is analyzed by the space-time event data estimation device 100, and, in accordance with a request from the space-time event data estimation device 100, reads out history information of various types of space-time event data and transmits the read-out information to the space-time event data estimation device 100.

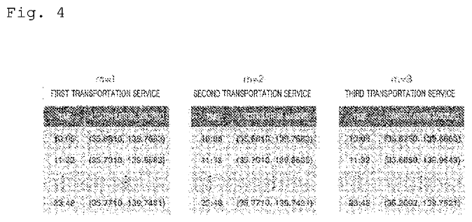

For example, the various types of space-time event data is a trip departure history (departure events) in various types of transportation services (e.g., taxis and Uber (registered trademark)), and is made up of sets {(tᵢ,sᵢ,mᵢ)}^{N}ᵢ₌₁ including a time tᵢ, a geospatial location sᵢ, and a type index mᵢ of the transportation service (see FIG. 4). Here, N is the number of data pieces. Let M be the set of transportation service type indices. In this context, there are spatial missing values. For example, taxi trips mainly occur at locations along roads. The following represents a set of geospatial zones (e.g., road zones) in which departure events were observed for the type m among the transportation services.

(g_{m,k},h_{m,k}]ₖ₌₁^{K}^{ₘ}

Here, Kₘ is the number of observation sections of the space-time event data that were determined in advance for the type m. The space-time event data storage device 12 is a web server that stores web pages, a database server equipped with a database, or the like.

Based on the information stored in the space-time event data storage device 12, the parameter estimation unit 16 estimates a relationship between the various types of space-time event data, extracts a low-dimensional representation of such information, and estimates a time development. This procedure will be described below using the above-described example. Consider the case where the various types of space-time event data is modelled using a multidimensional spatio-temporal Hawkes process. Here, the occurrence probability of a departure event in the type m space-time event data is modelled with the following strength function.

$$\begin{matrix}[ Formula . 5 ] & \\ {λ}_{m} ( t , s ) = {u}_{m} = {\sum }_{{t}_{i} < t} {a}_{m , {m}_{i}} {b}_{m} {e}^{- {b}_{m} ( t - {t}_{i} )} \cdot {e}_{m} {e}^{- \text{?}} \\ \text{?} \text{indicates text missing or illegible when filed} & ( 5 )\end{matrix}$$

Here, a power decay function is used as the function g(⋅) that represents the degree of influence of a past history. The following argument is true for any form of g(⋅). Here, uₘ>0 is a parameter representing the popularity of the type m transportation service, a_{m,n}>0 is a parameter representing the relationship between the type m transportation service and the type n transportation service, bₘ is a parameter that controls the temporal decay of the m-th data piece, and eₘ is a parameter that controls the spatial decay of the m-th data piece. These parameters are as follows.

u={uₘ}ₘ₌₁^{N}, a={a_{m,n}}_{m,e∈M}, b={bₘ}ₘ₌₁^{N}, e={eₘ}ₘ₌₁^{N}
In order to handle missing values, the strength function is rewritten as follows.

$$\begin{matrix} [ Formula . 6 ] & \\ \overline{λ} ( t , s ) = {u}_{m} + ( {\overline{λ}}_{m , k} - {u}_{m} ) - {e}^{- {b}_{m} ( i - {c}_{m , k} )} \cdot {e}^{- \text{?}} + {\sum }_{\text{?}} {a}_{m , {m}_{i}} {b}_{m} {e}^{- {b}_{m} ( t - {t}_{i} )} \cdot {e}^{- \text{?}} \\ \text{?} \text{indicates text missing or illegible when filed} & ( 6 )\end{matrix}$$

Here, the following is a new unknown parameter.

λ̅_{m,k}

Let (0,T) be the data observation period. The likelihood function of this model is written as follows.

$$\begin{matrix} [ Formula . 7 ] & \\ L ( u , a , b , e , {\{ {\overline{λ}}_{m , k} \}}_{m = 1 , k = 1}^{M , K} ) = {\sum }_{m ∈ M} {\sum }_{k = 1}^{{K}_{m}} {\int }_{0}^{T} {\int }_{{g}_{m , k}}^{{b}_{m , k}} {\overline{λ}}_{m} ( t , s ) dtds - {\sum }_{\text{?}} log ( {\overline{λ}}_{m} ( {t}_{i} , {s}_{i} ) ) \\ \text{?} \text{indicates text missing or illegible when filed} & ( 7 )\end{matrix}$$

In parameter estimation, find the following set of parameters that minimizes above function.

u, a, b, e, {λ̅_{m,k}}_{m=1,k=1}^{M,K}
The integral of the above expression can be calculated statistically. Because the above expression is differentiable for all the parameters, it is possible to apply a probabilistic gradient descent method (see NPL 3), for example.
[NPL 3] BOTTOU, Lon. Large-scale machine learning with stochastic gradient descent. In: Proceedings of COMPSTAT′2010. Physica-Verlag HD, 2010. p. 177-186.

As described above, based on the event occurrence history, the parameter estimation unit 16 estimates the set of parameters so as to optimize the likelihood function (see Formula 7) of the strength function expressing the event occurrence probability of the type m space-time event at the time t and the geospatial location s when the strength function is modelled, as shown in Formula 6, with use of the occurrence probability of the type m space-time event at the time t and the geospatial location s, the function expressing the degree of influence of the event occurrence history, the value representing the event occurrence probability in the observation section k that includes the time t and the geospatial location s, and the relationship between the type m and the type of the event occurrence history included in the observation section k, and here, the estimated parameters include the value of the strength function expressing the event occurrence probability in the observation sections, the relationship between types, and the function expressing the degree of influence of the event occurrence history.

The parameter storage unit 18 stores the set of optimum parameters obtained by the parameter estimation unit 16. The parameter storage unit 18 may be any storage means that enables the storage and reproduction of the set of estimated parameters. For example, the set of estimated parameters is stored in a database or a specified region of a built-in general-purpose storage device (a memory or a hard disk device).

Based on information that was accepted by the accepting unit 10 and indicates a time and a location for prediction, and based on the set of parameters stored in the parameter storage unit 18, the prediction unit 22 predicts an occurrence probability of various types of space-time event data with respect to the prediction time and the prediction location.

The output unit 24 outputs the prediction result obtained by the prediction unit 22. Here, “output” is a concept that includes display on a display device, printing by a printer, audio output, transmission to an external device, and the like. The output unit 24 may be thought to include an output device such as a display or a speaker, or may be thought to not include such an output device. The output unit 24 can be realized by driver software for an output device, or by an output device and driver software for that output device.

Effects of Space-Time Event Data Estimation Device of Embodiment of Present Invention

The following describes effects of the space-time event data estimation device 100 according to this embodiment of the present invention.

Learning Processing Routine

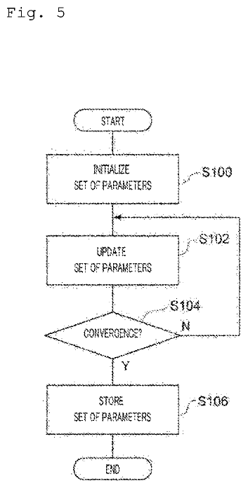

First, in the space-time event data estimation device 100, when history information of various types of space-time event data is received by the accepting unit 10, the history information of various types of space-time event data is stored in the space-time event data storage device 12. The space-time event data estimation device 100 then executes the learning processing routine shown in FIG. 5.

First, in step S100, the parameters

u, a, b, e, {λ̅_{m,k}}_{m=1,k=1}^{M,K}
are initialized.

In step S102, the parameters

u, a, b, e, {λ̅_{m,k}}_{m=1,k=1}^{M,K}
are updated so as to minimize the likelihood function in Formula 7.

In step S104, it is determined whether or not a predetermined convergence test condition has been satisfied, and the procedure returns to step S102 if the convergence test condition has not been satisfied, whereas the procedure moves to step S106 if the convergence test condition has been satisfied.

Note that the convergence test condition may be that the variation of the estimated parameters is less than or equal to a threshold value, or that a predetermined repetition count has been reached.

In step S106, the set of parameters

u, a, b, e, {λ̅_{m,k}}_{m=1,k=1}^{M,K}
that were last updated in step S102 is stored in the parameter storage unit 18, and then this learning processing routine is ended.

Data Prediction Processing Routine

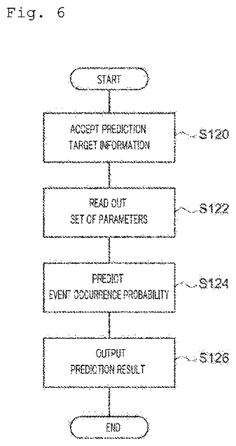

The following describes a data prediction processing routine shown in FIG. 6.

After the above-described learning processing routine has been executed, the set of parameters

u, a, b, e, {λ̅_{m,k}}_{m=1,k=1}^{M,K}
has been stored in the parameter storage unit 18, and information regarding a prediction time and a prediction location has been received, then the space-time event data estimation device 100 executes the data prediction processing routine shown in FIG. 6.

In step S120, the accepting unit 10 accepts information regarding a prediction time and a prediction location.

In step S122, the set of parameters

u, a, b, e, {λ̅_{m,k}}_{m=1,k=1}^{M,K}
stored in the parameter storage unit 18 is read out.

In step S124, in accordance with Formula 6, an occurrence probability is predicted for multiple types of space-time events at the prediction time and the prediction location based on the set of parameters read out in step S122.

In step S126, the output unit 24 outputs the prediction result obtained in step S124, and then the data prediction processing routine is ended.

As described above, according to the space-time event data estimation device of this embodiment of the present invention, it is possible to accurately estimate an occurrence probability for various types of space-time event data that includes missing values, by estimating parameters so as to optimize a likelihood function of a strength function expressing an event occurrence probability of a type m space-time event at a time t and a geospatial location s when the strength function is modelled with use of an occurrence probability of the type m space-time event at the time t and the geospatial location s, a function expressing a degree of influence of an event occurrence history, a value of a strength function representing the event occurrence probability in an observation section that includes the time t and the geospatial location s, and a relationship between the type m and the type of the event occurrence history included in the observation section, the estimated parameters including the value of the strength function expressing the event occurrence probability in the observation sections, the relationship between types, and the function expressing the degree of influence of the event occurrence history.

Note that the present invention is not limited to the embodiment described above, and various modifications and adaptations can be made without departing from the gist of the invention.

For example, although the example of the case where the various types of space-time event data is a departure history of various types of transportation services is described in the above embodiment, there is no limitation to this, and the various types of space-time event data may be other space-time event data.

Also, although the space-time event data estimation device 100 described above internally includes a computer system, if the WWW system is used, the “computer system” is a concept also including a web page provision environment (or display environment).

Also, although an embodiment in which a program has been installed in advance is described in this specification, the program can be provided in the form of being stored on a computer-readable recording medium, and can also be provided via a network.

### REFERENCE SIGNS LIST

10 Accepting unit
12 Space-time event data storage device
16 Parameter estimation unit
18 Parameter storage unit
20 Search unit
22 Prediction unit
24 Output unit
100 Space-time event data estimation device

1.-5. (canceled)

6. A computer-implemented method for determining aspects of space-time events, the method comprising:
receiving event history data, wherein the event history data includes a plurality of types of space-time events;
determining, based on the event history data, one or more parameters for optimizing a likelihood function of a strength function,
wherein the one or more parameters include:
an event occurrence probability in the observation sections,
a relationship between a type of a time-space event and a type of the event occurrence history included in the type of an observation section including the time and the location, and
a parameter of a function expressing a degree of influence of the event history data prior to the time,
wherein the strength function indicates an event occurrence probability of a type of a space-time event at a time at a geospatial location, and
wherein the strength function is modelled using the event occurrence probability, the relationship, and the parameter of the function; and
determining, based on the determined parameters for optimizing a likelihood function of the strength function, the event occurrence probability of the type of the space-time event at the time at the geospatial location; and
providing the event occurrence probability as an estimate of an event occurrence.

7. The computer-implemented method of claim 6, wherein the strength function is based at least on a combination of:
a probability of the space-time event occurrence of the type at the time at the location,
an influence from past event occurrences,
a relationship between types of observation sections,
a time period associated with an observation section, and
a spatial domain of the observation section.

8. The computer-implemented method of claim 6, wherein the likelihood function based on the strength function simultaneously complement the strength function in a missing domain and estimate the parameter for optimization.

9. The computer-implemented method of claim 6, wherein the strength function is modelled using a multidimensional spatio-temporal Hawkes process.

10. The computer-implemented method of claim 6, the method further comprising:
training, based on the received event history data, the likelihood function using a convergence test.

11. The computer-implemented method of claim 6, wherein the plurality of types of space-time events include a first type associated with a first departure time of a first trip using a taxi service and a second type associated with a second departure time of a second trip using a share-ride service.

12. The computer-implemented method of claim 11, the method further comprising:
determining, based on the determined parameters for optimizing a likelihood function of the strength function, the event occurrence probability of the first type of space-time events associated with the first departure time of the first trip using the taxi-service at the location; and
providing the estimate of the first departure time of the first trip using the taxi-service at the location.

13. A system for determining aspects of space-time events, the system comprises:
a processor; and
a memory storing computer-executable instructions that when executed by the processor cause the system to:
receive event history data, wherein the event history data includes a plurality of types of space-time events;
determine, based on the event history data, one or more parameters for optimizing a likelihood function of a strength function,
wherein the one or more parameters include:
an event occurrence probability in the observation sections,
a relationship between a type of a time-space event and a type of the event occurrence history included in the type of an observation section including the time and the location, and
a parameter of a function expressing a degree of influence of the event history data prior to the time,
wherein the strength function indicates an event occurrence probability of a type of a space-time event at a time at a geospatial location, and
wherein the strength function is modelled using the event occurrence probability, the relationship, and the parameter of the function; and
determine, based on the determined parameters for optimizing a likelihood function of the strength function, the event occurrence probability of the type of the space-time event at the time at the geospatial location; and
provide the event occurrence probability as an estimate of an event occurrence.

14. The system of claim 13, wherein the strength function is based at least on a combination of:
a probability of the space-time event occurrence of the type at the time at the location,
an influence from past event occurrences,
a relationship between types of observation sections,
a time period associated with an observation section, and
a spatial domain of the observation section.

15. The system of claim 13, wherein the likelihood function based on the strength function simultaneously complement the strength function in a missing domain and estimate the parameter for optimization.

16. The system of claim 13, wherein the strength function is modelled using a multidimensional spatio-temporal Hawkes process.

17. The system of claim 13, the computer-executable instructions when executed further causing the system to:
train, based on the received event history data, the likelihood function using a convergence test.

18. The system of claim 13, wherein the plurality of types of space-time events include a first type associated with a first departure time of a first trip using a taxi service and a second type associated with a second departure time of a second trip using a share-ride service.

19. The system of claim 18, the computer-executable instructions when executed further causing the system to:
determine, based on the determined parameters for optimizing a likelihood function of the strength function, the event occurrence probability of the first type of space-time events associated with the first departure time of the first trip using the taxi-service at the location; and
provide the estimate of the first departure time of the first trip using the taxi-service at the location.

20. A computer-readable non-transitory recording medium storing computer-executable instructions that when executed by a processor cause a computer system to:
receive event history data, wherein the event history data includes a plurality of types of space-time events;
determine, based on the event history data, one or more parameters for optimizing a likelihood function of a strength function,
wherein the one or more parameters include:
an event occurrence probability in the observation sections,
a relationship between a type of a time-space event and a type of the event occurrence history included in the type of an observation section including the time and the location, and
a parameter of a function expressing a degree of influence of the event history data prior to the time,
wherein the strength function indicates an event occurrence probability of a type of a space-time event at a time at a geospatial location, and
wherein the strength function is modelled using the event occurrence probability, the relationship, and the parameter of the function; and
determine, based on the determined parameters for optimizing a likelihood function of the strength function, the event occurrence probability of the type of the space-time event at the time at the geospatial location; and
provide the event occurrence probability as an estimate of an event occurrence.

21. The computer-readable non-transitory recording medium of claim 20, wherein the strength function is based at least on a combination of:
a probability of the space-time event occurrence of the type at the time at the location,
an influence from past event occurrences,
a relationship between types of observation sections,
a time period associated with an observation section, and
a spatial domain of the observation section.

22. The computer-readable non-transitory recording medium of claim 20, wherein the likelihood function based on the strength function simultaneously complement the strength function in a missing domain and estimate the parameter for optimization.

23. The computer-readable non-transitory recording medium of claim 20, wherein the strength function is modelled using a multidimensional spatio-temporal Hawkes process.

24. The computer-readable non-transitory recording medium of claim 20, the computer-executable instructions when executed further causing the system to:
train, based on the received event history data, the likelihood function using a convergence test.

25. The computer-readable non-transitory recording medium of claim 20, wherein the plurality of types of space-time events include a first type associated with a first departure time of a first trip using a taxi service and a second type associated with a second departure time of a second trip using a share-ride service, and the computer-executable instructions when executed further causing the system to:
determine, based on the determined parameters for optimizing a likelihood function of the strength function, the event occurrence probability of the first type of space-time events associated with the first departure time of the first trip using the taxi-service at the location; and
provide the estimate of the first departure time of the first trip using the taxi-service at the location.
